(19) United States
(12) Patent Application Publication
(10) Pub. No.: US 2014/0166218 A1
(43) Pub. Date: Jun. 19, 2014

(54) Chain Guide for Dual Roller Blind

(71) Applicant: Philip Ng, Thornhill (CA)

(72) Inventor: Philip Ng, Thornhill (CA)

(21) Appl. No.: 13/713,947

(22) Filed: Dec. 13, 2012

(51) Int. Cl. E06B 9/42

(52) U.S. Cl. CPC E06B 9/42
USPC 160/120

(57) ABSTRACT

A chain guide for a dual roller blind. The dual roller blind includes a first or inner and a second or outer roller tube. The roller tubes are mounted between a common pair of end plates and have clutches at common ends that are operatively associated with the same end plate and driven by chains. The chain guide comprises at least four rollers and at least one cover plate. The rollers are each mounted on separate pins and each pin has first and second ends, with the first ends fixed to the end plate that is operatively associated with the blind's clutches. Two of the rollers are operatively associated with the inner roller tube and sized and positioned to accommodate the receipt of the chain or cord of the inner roller tube. Two of the rollers are operatively associated with the outer roller tube and sized and positioned to accommodate the receipt of the chain or cord of the outer roller tube. The cover plate covers the second ends of the pins to prevent the chains or cords from being displaced from between adjacent rollers when received therebetween.

### FIELD

This invention relates generally to roller blinds or roller shades, and in particular to a chain guide for a dual roller blind or roller shade.

### BACKGROUND

Roller blinds, or roller shades as they are sometimes referred to, are commonly mounted on windows for privacy purposes and to limit light intrusion. Modern roller blinds typically employ a length of fabric wound upon a roller tube. As desired, the fabric can be lowered in front of the window or retracted onto the roller tube through the operation of a clutch mechanism powered by a looped chain or cord. The clutch serves as a means to impart rotational movement to the roller tube when the chain or cord is pulled in one direction or the other.

In a number of applications it is desirable to utilize a roller shade having two roller tubes and two fabrics wound thereon. Such a structure is often referred to as a dual roller shade. In many instances the fabric closest to the window in a dual shade application will be relatively sheer in order to limit light intrusion, but not prevent it completely. Often a relatively opaque fabric would be wound upon the roller tube furthest from the window. The dual roller blind will thus permit an operator to utilize one, or both, of the blind fabrics in order to permit a desired degree of light intrusion or to effectively block out most, if not essentially all, transmission of light into a room.

Such dual roller blinds essentially consist of two separate roller blinds attached to common end plates or end brackets. Each roller blind will thus include its own roller tube, clutch and chain or cord to drive the clutch in a desired direction so as to either unwind or retract blind fabric from or onto the roller tube. Since one of the roller tubes will be mounted in front of the other, the two sets of chains or cords will hang vertically downward from the clutches, one generally in front of the other. In order to accommodate both sets of chains or cords, the fascia of the blind must typically be notched or slotted to ensure that the chains or cords do not contact the fascia during operation. Any contact between the chains or cords and the fascia will cause undesirable noise and could also damage the fascia or potentially cause it to fall off the blind, presenting a safety concern. Notching or slotting the fascia, although necessary with currently available dual roller blinds, presents an undesirable aesthetic appearance to the bottom surface of the blind and can in some instances add a manufacturing step that can increase costs. Further, the chain or cord that hangs downwardly from the outer roller tube can sometimes come into contact with other objections and can represent an increased choking hazard on account of its distance away from the window glass.

### SUMMARY

The invention therefore provides a chain guide for a dual roller blind, the dual roller blind including a first or inner and a second or outer roller tube, the roller tubes mounted between a common pair of end plates and having clutches at common ends that are operatively associated with the same end plate and driven by chains or cords, the chain guide comprising at least four rollers, said rollers each mounted on separate pins with each of said pins having first and second ends, said first ends of said pins fixed to the end plate that is operatively associated with the blind's clutches, two of said rollers operatively associated with the inner roller tube and sized and positioned to accommodate the receipt of the chain or cord of the inner roller tube and two of said rollers operatively associated with the outer roller tube and sized and positioned to accommodate the receipt of the chain or cord of the outer roller tube, said chain guide including at least one cover plate, said cover plate covering said second ends of said pins to prevent the chains or cords from being displaced from between adjacent rollers when received therebetween.

Further aspects of the invention will become apparent from the following description taken together with the accompanying drawings.

### BRIEF DESCRIPTION OF THE DRAWINGS

For a better understanding of the present invention, and to show more clearly how it may be carried into effect, reference will now be made, by way of example, to the accompanying drawings which show exemplary embodiments of the present invention in which:

FIG. 1 is a lower front perspective view of a typical prior art dual roller blind.

FIG. 2 is a sectional view taken along the line 2-2 of FIG. 1, wherein the roller tube and blind fabric have been removed.

FIG. 3 is a lower front perspective view of a dual roller blind incorporating an embodiment of the present invention.

FIG. 4 is a sectional view taken along the line 4-4 of FIG. 3, wherein the roller tube and blind fabric have been removed.

FIG. 5 is a view similar to FIG. 4 wherein the cover plate of the chain guide has been partially rotated out of position.

FIG. 6 is a rear view of the left hand end of a dual roller blind incorporating a chain guide in accordance with an embodiment of the present invention.

FIG. 7 is a sectional view taken along the line 7-7 of FIG. 4.

FIG. 8 is a sectional view taken along the line 8-8 of FIG. 4.

FIG. 9 is a sectional view of an alternate embodiment of the invention similar to FIG. 4.

FIG. 10 is a view similar to FIG. 9 wherein the cover plate of the chain guide has been partially rotated out of position.

### DESCRIPTION

The present invention may be embodied in a number of different forms. The specification and drawings that follow describe and disclose some of the specific forms of the invention.

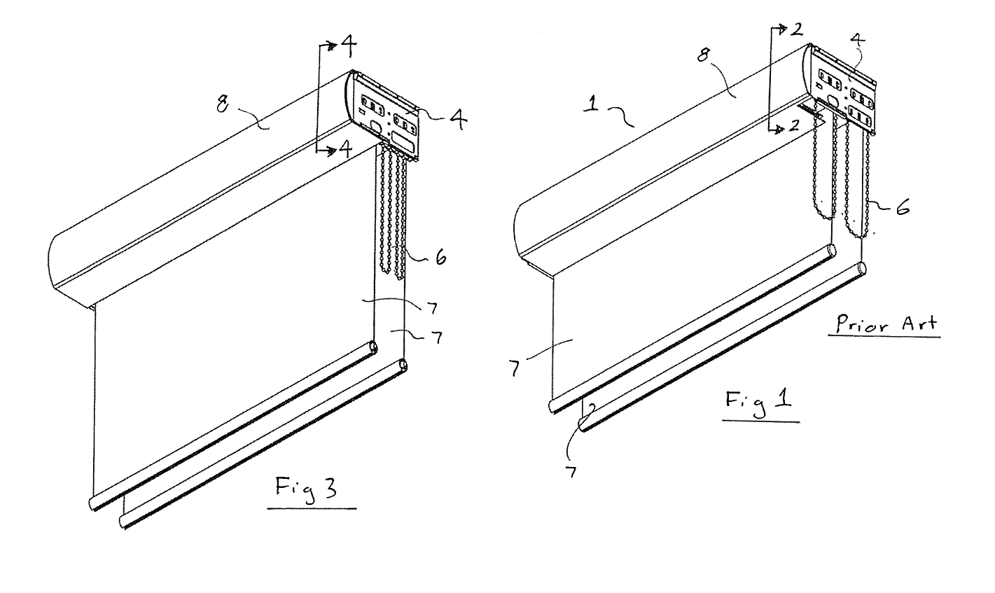

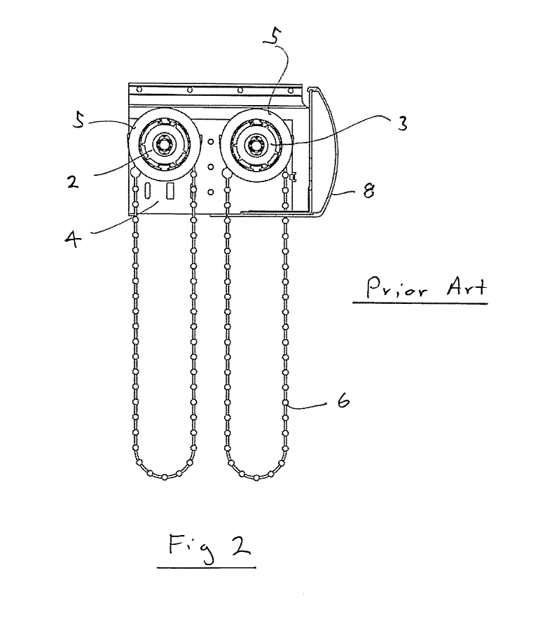

In the attached drawings, there is shown a dual roller blind represented generally by the reference numeral 1. FIGS. 1 and 2 depict current state of the art dual roller blinds, whereas FIGS. 3 and 4 depict a dual roller blind incorporating a chain guide in accordance with an embodiment of the present invention.

In general, roller blind 1 is comprised of a first 2 (inner) and a second 3 (outer) roller tube, with each roller tube mounted between a common pair of end plates 4. The roller tubes have clutches 5 at common ends such that the clutches are operatively associated with the same end plate. Each clutch is driven by a looped chain or cord 6. Blind fabric 7 is wound upon the roller tubes and the tubes are enclosed by a fascia 8. As shown in FIG. 1, in currently available dual roller blinds, the bottom portion of the fascia adjacent to the chains or cords is notched or slotted along most of its depth in order to accommodate the positioning of the chains or cords.

In accordance with an embodiment of the invention, there is provided a chain guide 9 that is comprised generally of four rollers 10. Each roller is mounted on a separate pin or axle 11. The pins have first and second ends with their first ends fixed to the end plate that is operatively associated with the blind's clutches. The pins extend outwardly from the end plate at a generally perpendicular angle. As will be appreciated, rollers 10 are preferably sized to accommodate the receipt of the chain or cord of the roller blind thereover. From a thorough understanding of the invention it will be further appreciated that the rollers in one embodiment may have a concave exterior surface to facilitate the receipt of the chain or cord. In addition, the rollers may have a friction enhancing exterior intended to encourage the rollers to rotate when the chain or cord associated with the roller is moved upwardly or downwardly in order to raise or lower the blind fabric. While a variety of different friction enhancing surfaces or means could be utilized, in one embodiment the rollers (or their exterior surfaces) can be formed from a relatively soft and resilient plastic, silicone, or rubber-like material which will tend to grip the chain or cord, thereby causing the rollers to rotate as the chain or cord is moved. Encouraging the rollers to move with the chain or cord not only helps to reduce friction and wear of the rollers, but also minimizes the production of unwanted noise.

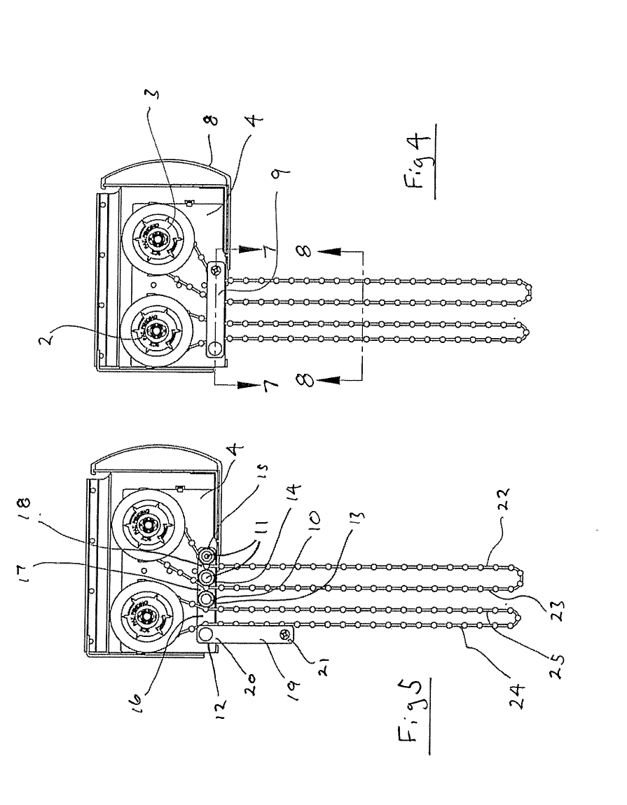

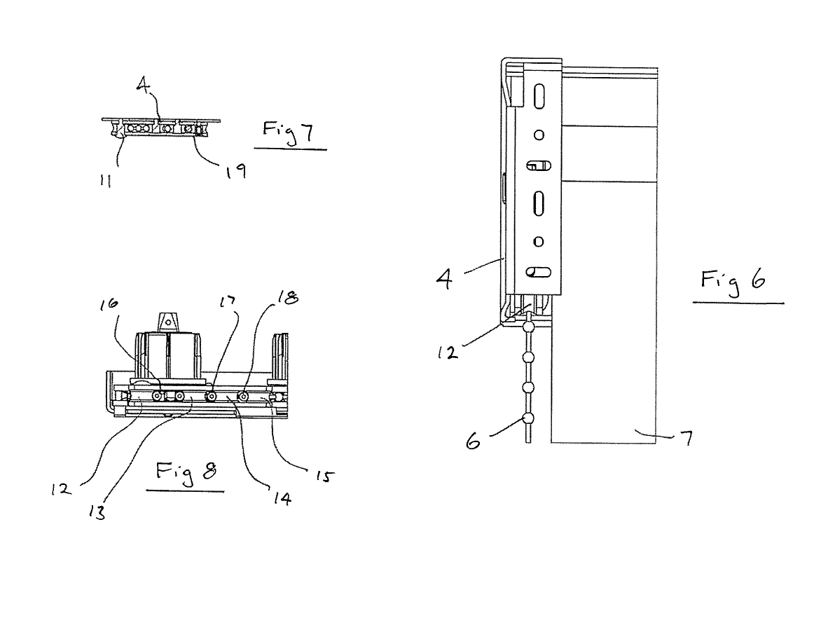

In the embodiment of the invention shown in FIGS. 4 and 5, rollers 10 are positioned along the inner surface of the end plate in a spaced apart configuration and in a generally horizontal plane. As indicated, chain guide 9 includes four rollers (labelled 12, 13, 14 and 15 respectively) positioned in a generally horizontal plane. It will be appreciated that rollers 12, 13, 14 and 15 will present spaces 16, 17 and 18 between adjacent rollers. One leg 22 of the chain or cord of outer roller tube 1 will be received within space 18 while the other leg 23 of the same chain or cord will be received within space 17. As shown specifically in FIG. 5, in the embodiment depicted in the drawings, both legs (24 and 25) of the chain or cord associated with inner roller 2 are received within space 16. In order to help ensure contact of the chain associated with inner roller tube 3 with rollers 12 and 13, the rollers are preferably positioned generally beneath inner roller tube 2 and at a spacing that is less than the exterior diameter of the clutch associated with roller tube 2. In this manner both legs of the chain or cord associated with inner roller tube 2 will be drawn slightly inwardly (in a vertical plane), thereby causing each leg of the chain or cord to contact one of rollers 12 or 13. In the case of rollers 14 and 15, each of the rollers are preferably off-set toward the back of the end plate such that they are horizontally displaced backwardly from the longitudinal axis of the second or outer roller tube. With rollers 14 and 15 being off-set toward the back of the end plate, legs 22 and 23 of the chain or cord wound around the clutch associated with the outer roller tube must be routed backwardly (i.e. in a manner having a horizontal component), after which leg 23 is received through space 17 and leg 22 received through space 18.

As will be appreciated from an understanding of the invention and from an examination of the drawings (and in particular FIG. 5), the off-setting of at least rollers 14 and 15 toward the rear of the end plate results in the pair of chains or cords hanging in vertical planes that are considerably closer to one another than in a case of currently available dual roller blinds, and in a more confined region toward the rear portion of the end plate. Such a structure significantly reduces the need to notch or slot the fascia and also causes both sets of cords or chains to hang downwardly in a side-by-side relationship, relatively close to the window pane.

In accordance with the invention there is further provided at least one cover plate 19 covering the second or outer ends of pins 11. Cover plate 19 helps to prevent the chains or cords received within spaces 16, 17 and 18 from being displaced or from jumping out from between adjacent rollers. To assist in the installation of the blind, and in particular to facilitate the entry of the chains or cords into spaces 16, 17 and 18, the cover plate may be rotationally secured to one of the pins. In the embodiment depicted in FIGS. 4 and 5, the cover plate has a first end 20 and a second end 21. First end 20 may be rotationally secured to one of pins 11 with second end 21 releasably secured to another of the pins, thereby permitting the cover to be rotated out of position to permit the entry of the chains or cords into their respective spaces between adjacent rollers. The cover can thereafter be rotated back into position and secured in place to prevent the chains or cords from escaping from between their respective rollers. In one embodiment second end 21 of cover plate 19 is secured to one of the pins through the use of a screw or other fastener.

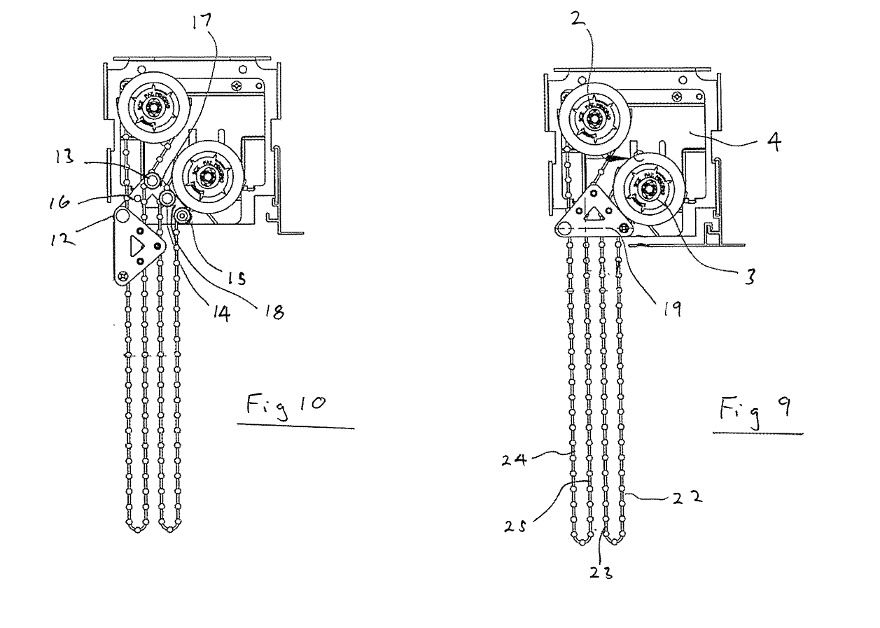

FIGS. 9 and 10 illustrate an alternate embodiment of the invention. Here pins 11 are positioned in a generally triangular configuration so as to enable inner and outer roller tubes 2 and 3 to be located on the end plates in a manner that minimizes their horizontal projection into the room when mounted in front of a window. That is, in situations where it may be desirable to confine the entire roller blind within the window build-out, the utilization of a chain guide in accordance with the embodiment of the invention shown in FIGS. 9 and 10 will permit the rollers to be off-set both vertically and horizontally from their positions as shown in FIG. 4 to their positions as shown in FIG. 9. In this off-set position the use of a generally triangular configured chain guide permits the rollers to be located such that their circumferential surfaces effectively overlap a common vertical plane, thus allowing them to be positioned closer to one another (in a horizontal sense) than is possible when their longitudinal axes are in the same horizontal plane. The positioning of the roller tubes as shown in FIG. 9 still permits their respect chains or cords to hang downwardly from the roller blind in a defined and controlled location without becoming entangled. It will be appreciated that such a structure permits the utilization of a dual blind having a reduced horizontal projection into the room within which it is mounted.

The embodiment of the chain guide shown in FIGS. 9 and 10 functions essentially the same as that a shown in FIGS. 4 and 5. The primary difference in the two embodiments concerns the positioning of roller 13 at the apex of the triangular configuration and the positioning of roller 14 in a horizontal plane above roller 15, but below roller 13. In this manner it will be appreciated that the chains or cords from roller tubes 2 and 3 can be routed around rollers 12, 13, 14 and 15 in a manner that permits the chains to hang downward in vertical planes that are off-set toward the back of the roller blind, as in the case of the embodiment shown in FIG. 4, while at the same time permitting the roller tubes to be off-set in a horizontal plane to reduce the projection of the blind into the room.

It will thus be appreciated from a thorough understanding of the invention that there is presented an improved chain guide that permits the chains or cords in a dual roller blind to be off-set toward the rear of the blind's end plate. In so doing there is removed the need for an enlarged slot or notch in the fascia of the blind, thereby enhancing the overall appearance of the blind. The structure of the present invention further permits the cords or chains to hang downwardly closer to the rear of the blind, and hence closer to the window pane, helping to minimize the likelihood of the chains or cords coming into contact with foreign objects and also helping to reduce their potential choking hazard. In one embodiment the invention facilitates the construction of a dual roller blind that has a reduced horizontal projection into the room within which it is mounted.

It is to be understood that what has been described are the preferred embodiments of the invention. The scope of the claims should not be limited by the preferred embodiments set forth above, but should be given the broadest interpretation consistent with the description as a whole.

I claim:

1. A chain guide for a dual roller blind, the dual roller blind including a first or inner and a second or outer roller tube, the roller tubes mounted between a common pair of end plates and having clutches at common ends that are operatively associated with the same end plate and driven by chains or cords, the chain guide comprising:
at least four rollers, said rollers each mounted on separate pins with each of said pins having first and second ends, said first ends of said pins fixed to the end plate that is operatively associated with the blind's clutches, two of said rollers operatively associated with the inner roller tube and sized and positioned to accommodate the receipt of the chain or cord of the inner roller tube and two of said rollers operatively associated with the outer roller tube and sized and positioned to accommodate the receipt of the chain or cord of the outer roller tube,
said chain guide including at least one cover plate, said cover plate covering said second ends of said pins to prevent the chains or cords from being displaced from between adjacent rollers when received therebetween.

2. The chain guide as claimed in claim 1 wherein said rollers are positioned in a spaced apart configuration and in a generally horizontal plane.

3. The chain guide as claimed in claim 2 wherein at least the pins upon which said rollers operatively associated with the outer roller tube are mounted are off-set toward the back of the end plate such that the chain or cord of the outer roller tube is off-set toward the back of the blind when hanging therefrom.

4. The chain guide as claimed in claim 3 wherein said cover plate is rotationally secured to one of said pins.

5. The chain guide as claimed in claim 3 wherein said cover plate has a first and a second end, said first end rotationally secured to one of said pins and said second end releasably secured to another of said pins.

6. The chain guide as claimed in claim 5 wherein said second end of said cover plate is releasably secured to one of said pins through the use of a fastener.

7. The chain guide as claimed in claim 1 wherein said rollers have concave exterior surfaces to facilitate the receipt of a chain or cord thereabout.

8. The chain guide as claimed in claim 6 wherein said rollers have a friction enhancing exterior surface to encourage said rollers to rotate when the chains or cords associated with said rollers are moved in order to raise or lower the associated blind fabrics.

9. The chain guide as claimed in claim 2 wherein the pins upon which said rollers operatively associated with the outer roller tube are mounted are off-set toward the back of the end plate such that the chain or cord associated with the outer roller tube hangs downwardly in vertical planes that are horizontally rearwardly off-set from the longitudinal axis of the outer roller tube.

10. The chain guide as claimed in claim 1 wherein said rollers are positioned in a generally triangular configuration.

11. The chain guide as claimed in claim 10 wherein one of the pins upon which one of said rollers operatively associated with the inner roller tube is mounted at the apex of said triangular configuration.

12. The chain guide as claimed in claim 11 wherein at least the pins upon which said rollers operatively associated with the outer roller tube are mounted are off-set toward the back of the end plate such that the chain or the cord associated with the outer roller tube is off-set horizontally rearwardly from the longitudinal axis of the outer roller tube.

13. The chain guide as claimed in claim 12 wherein said cover plate is rotationally secured to one of said pins.

14. The chain guide as claimed in claim 13 wherein said rollers have concave exterior surfaces to facilitate the receipt of a chain or cord thereabout.

15. The chain guide as claimed in claim 14 wherein said rollers have a friction enhancing exterior surface to encourage said rollers to rotate when the chains or cords associated with said rollers are moved in order to raise or lower the associated blind fabrics.

16. The chain guide as claimed in claim 11 wherein the pins upon which said rollers operatively associated with the outer roller tube are mounted are off-set horizontally rearwardly from the longitudinal axis of the outer roller tube, said pin associated with the inner roller tube mounted at the apex of said triangular configuration off-set horizontally rearwardly from said pins upon which said rollers operatively associated with the outer roller tube are mounted.
